(19) United States
(12) Patent Application Publication
(10) Pub. No.: US 2010/0221062 A1
(43) Pub. Date: Sep. 2, 2010

(54) Ball and Socket Connectors With Substructure

(76) Inventor: JoeBen Bevirt, Santa Cruz, CA (US)

Correspondence Address: MICHAEL A. GUTH, 2-2905 EAST CLIFF DRIVE, SANTA CRUZ, CA, 95062, US

(21) Appl. No.: 12/649,247

(22) Filed: Dec. 29, 2009

Related U.S. Application Data
(60) Provisional application No. 61/203,880, filed on Dec. 29, 2008.

(51) Int. Cl. F16C 11/06

(52) U.S. Cl. 403/122

(57) ABSTRACT

A ball and socket connector with a contact surface of a material selected for a first property, such as a frictional property, with a substructure of a second material selected for a second property, such as its elastic property. A chain of ball and socket connectors of connectors with a substructure.

### CROSS-REFERENCE TO RELATED APPLICATIONS

This application claims priority to U.S. Provisional Application No. 61/203,880 to Bevirt, filed Dec. 29, 2008, which is hereby incorporated by reference in it entirety.

### BACKGROUND

1. Field of the Invention

This invention relates to connectors, and more specifically to connectors with a substructure.

2. Description of Related Art

A typical ball and socket connector is made of a single material. Although some multi-material connectors are known, there exists a gap in the technology between the goal of having a connector with a good grip on the mating connector, which is not subject to creep and therefore cause relaxation of the connection, and the goal of having appropriate stick-slip properties.

When a series of connectors are used in a positioning chain, such as a support arm, or the leg of a tripod, a design goal may be that there is not too high of a static friction relative to the dynamic friction. Achievement of this goal is hampered by the fact that many materials that have this property also are subject to creep, and that over time the tightness of the joint relaxes.

What is called for is a ball and socket connector, and a chain of such connectors, wherein the mating surfaces are of a material that allows for a desired property, such as stick-slip, in a connector that is held in friction using a material less subject to creep or plastic deformation.

### SUMMARY

A ball and socket connector with a contact surface of a material selected for a first property, such as a frictional property, with a substructure of a second material selected for a second property, such as its elastic property. A chain of ball and socket connectors of such connectors.

### BRIEF DESCRIPTION OF THE DRAWINGS

FIG. 1 is a side view of a chain of ball and socket connectors according to some embodiments of the present invention.

FIG. 2A is a perspective partial cut-away view of a connector with a substructure according to some embodiments of the present invention.

FIG. 2B is a perspective view of a skeletal substructure according to some embodiments of the present invention.

FIG. 2C is a side view of a connector according to some embodiments of the present invention.

FIG. 2D is a cross-sectional view of a connector according to some embodiments of the present invention.

FIG. 2E is a cross-sectional view of a connector according to some embodiments of the present invention.

FIG. 3A is a perspective partial cross-section of a connector with a substructure according to some embodiments of the present invention.

FIG. 3B is a perspective view of a skeletal substructure according to some embodiments of the present invention.

FIG. 3C is a side view of a connector according to some embodiments of the present invention.

FIG. 3D is a cross-sectional view of a connector according to some embodiments of the present invention.

FIG. 3E is a cross-sectional view of a connector according to some embodiments of the present invention.

FIG. 4A is a perspective partial cross-section of a connector with a substructure according to some embodiments of the present invention.

FIG. 4B is a perspective view of a skeletal substructure according to some embodiments of the present invention.

FIG. 4C is a side view of a connector according to some embodiments of the present invention.

FIG. 4D is a cross-sectional view of a connector according to some embodiments of the present invention.

FIG. 4E is a cross-sectional view of a connector according to some embodiments of the present invention.

FIG. 5 is a view of a connector and its sub-structure with a circumferential element according to some embodiments of the present invention.

FIGS. 6A-C are views of a substructure and connector with a non-linear circumferential band according to some embodiments of the present invention.

### DETAILED DESCRIPTION

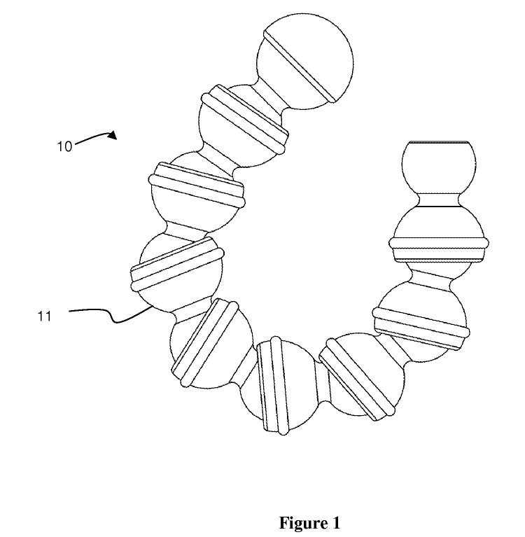

FIG. 1 illustrates a plurality of ball and socket joint connectors 10 according to some embodiments of the present invention. A connector 11 has a first end portion and a second end portion. A socket engaging end surface is present at the first end. The first end portion may be substantially hollowed out in some embodiments. The ball portions and the socket portions of the connectors may be of spherical shape and adapted to have their respective outer and inner spherical shapes mate together in some embodiments.

The second end portion has a body with an internal socket receiving cavity. The inner surface of the an internal socket receiving cavity is adapted to fit over the socket engaging end surface of another connector, or of another piece with a similar socket engaging end surface. A neckdown may separate the first end portion from the second end portion. A stop nub may act as a mechanical stop to prevent over angulation and possible unintentional separation of a ball and socket joint connector pair in some embodiments. In some embodiments, there may be a hole through the center of the connector. In some embodiments, a connector may include a gripping portion adapted to provide better frictional support around the outside of the connector.

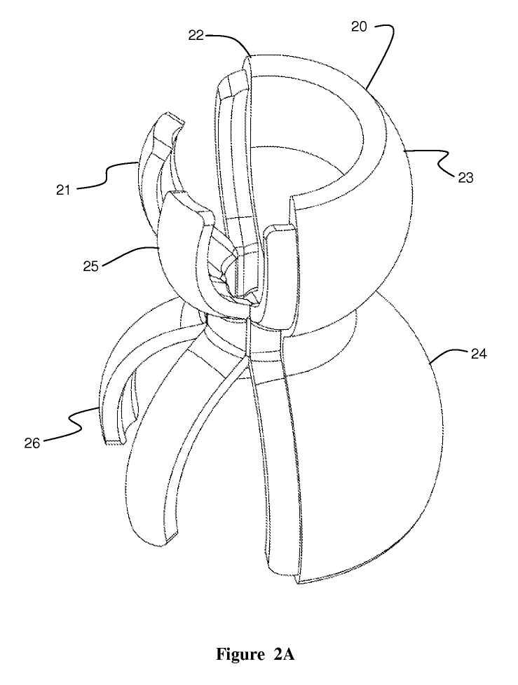

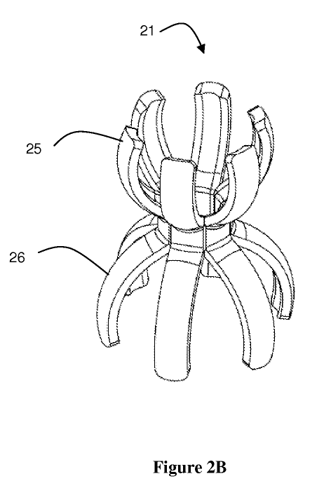

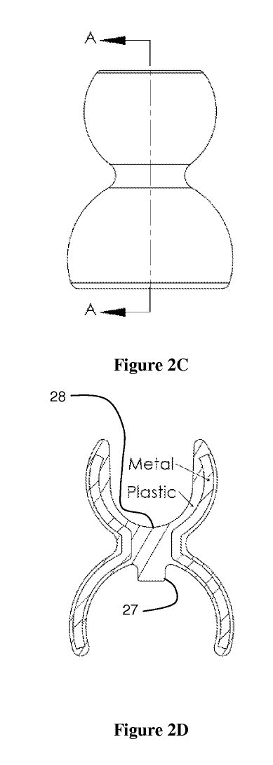

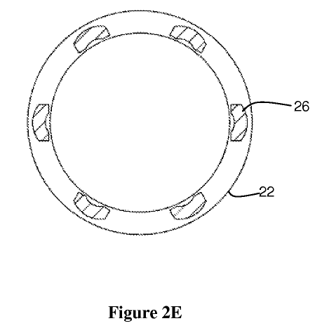

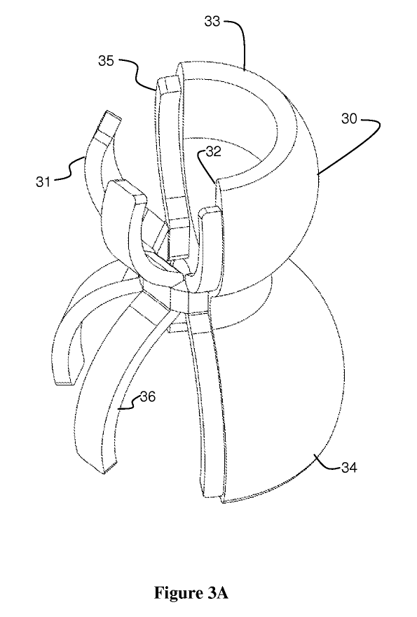

In some embodiments of the present invention, as seen in FIGS. 2A-E, a connector 20 has a first end 23 and a second end 24. The first end 23 has a socket engaging end surface. The second 24 has an internal socket receiving cavity. The connector 20 has an outer portion 22 surrounding a substructure 21. The outer portion may be of a plastic material. The outer portion may be of a material selected for its frictional or stick slip properties.

The substructure 21 is adapted to provide support for the connector such that connectors may be connected into chains, which requires the ball to fit into the socket, without plastic deformation of the substructure. For example, in the case of a hollow ball embodiment, the ball may deform slightly, by shrinking somewhat, and the socket may expand somewhat, when one connector is connected to another. By using an appropriate material for the substructure, the amount of deflection needed for attachment of the connectors can be kept within a range that is within the elastic bending range of the substructure. However, the outer portion of the connector may be of a material selected for frictional or stick slip properties. Often such materials may not have sufficient elastic range to allow for the attachment of two connectors made solely of such materials without plastic deflection. Further, such materials may also be subject to creep. Thus, by utilizing a substructure that remains within an elastic range, materials that have desired stick slip properties, but may creep, can be used in the outer portion 22 without creep based relaxation on the tension in the ball and socket joint. The substructure may be made of metal in some embodiments. The substructure may be made of a stiffer plastic in some embodiments.

Although the outer portion is shown as being a full outer portion, in some embodiments the outer portion may consist of material only in the area where it is directly supported by the substructure, resulting in a look of a plurality of support fingers. This may be utilized in some embodiments.

The substructure 21 may be an integrated one piece structure in some embodiments, providing a structure for both the ball and the socket of a connector. The socket portion 26 of the substructure 21 is adapted to provide flexural support for the socket, allowing material of a different type to be used for contacting the ball. The ball portion 25 of the substructure 21 is adapted to provide flexural support for the ball, allowing a material of a different type to be used for contacting the ball. The connector may be manufactured using a co-molding, or overmolding, process. The substructure may be molded in a first step, and then the structure laid in a mold in which the outer portion is overmolded onto the substructure.

FIG. 2D illustrates a cross-sectional view of a connector 20 according to some embodiments of the present invention. The substructure 21 is seen covered externally by the outer portion 22. In some embodiments, the center 28 is closed. In some embodiments, the center may have a passageway, which may allow for the passage of wiring, fluids, or other items. A mechanical stop 27 prevents over rotation of the connectors in some embodiments. FIG. 2E illustrates a cross-sectional view of the second end 24 of the connector 20. The ribs 26 of the skeletal substructure are seen with curved profiles. In some embodiments, the curved profiles will create planes parallel to the inner and outer surfaces of the connector. In some embodiments, the curved profiles may be selected for their bending section properties in order to provide desired elastic properties.

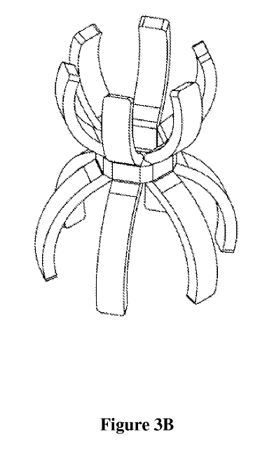

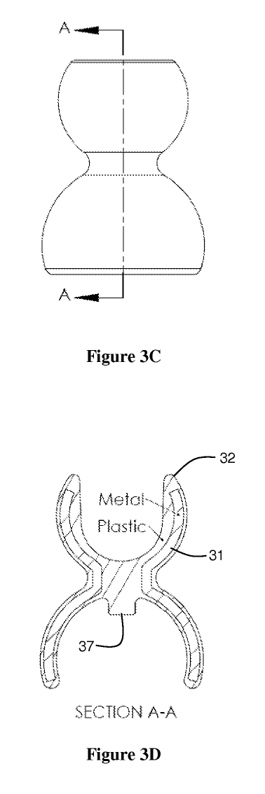

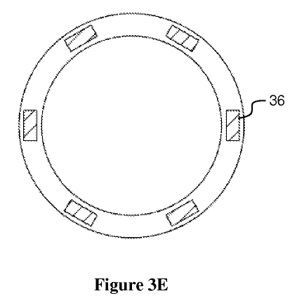

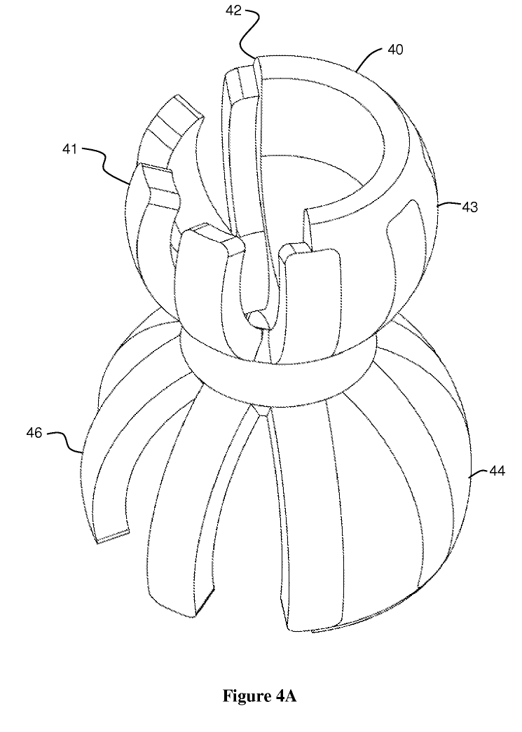

In some embodiments of the present invention, as seen in FIGS. 3A-E, a connector 30 has a first end 33 and a second end 34. The first end 33 has a socket engaging end surface. The second 34 has an internal socket receiving cavity. The connector 30 has an outer portion 32 surrounding a substructure 31. The outer portion may be of a plastic material. The outer portion may be of a material selected for its frictional or stick slip properties.

The substructure 31 may be an integrated one piece structure in some embodiments, providing a structure for both the ball and the socket of a connector. The socket portion 36 of the substructure 31 is adapted to provide flexural support for the socket, allowing material of a different type to be used for contacting the ball. The ball portion 35 of the substructure 31 is adapted to provide flexural support for the ball, allowing a material of a different type to be used for contacting the ball. The connector may be manufactured using a co-molding, or overmolding, process. The substructure may be molded in a first step, and then the structure laid in a mold in which the outer portion is overmolded onto the substructure.

FIG. 3D illustrates a cross-sectional view of a connector 30 according to some embodiments of the present invention. The substructure 31 is seen covered externally by the outer portion 32. In some embodiments, the center 38 is closed. In some embodiments, the center may have a passageway, which may allow for the passage of wiring, fluids, or other items. A mechanical stop 37 prevents over rotation of the connectors in some embodiments. FIG. 3E illustrates a cross-sectional view of the second end 34 of the connector 30. The ribs 36 of the skeletal substructure are seen with rectangular profiles.

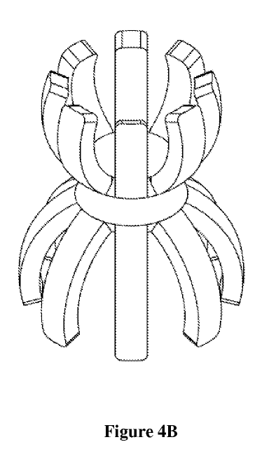

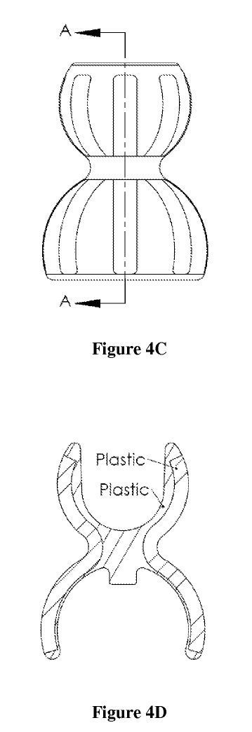

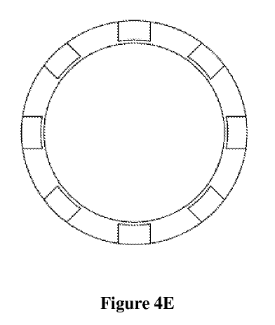

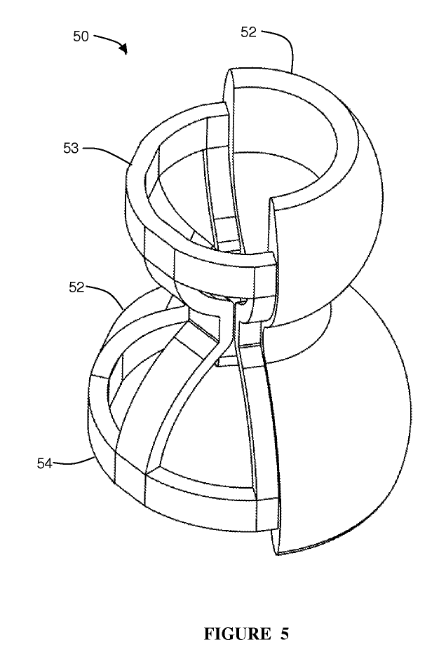

In some embodiments of the present invention, as seen in FIGS. 4A-E, a connector 40 has a first end 43 and a second end 44. The first end 43 has a socket engaging end surface. The second 44 has an internal socket receiving cavity. The connector 40 has an outer portion 42 partially surrounding a substructure 41. The outer portion may be of a plastic material. The outer portion may be of a material selected for its frictional or stick slip properties.

The substructure 41 is adapted to provide support for the connector such that connectors may be connected into chains, which requires the ball to fit into the socket, without plastic deformation of the substructure. The substructure may be made of a stiffer plastic in some embodiments. The substructure 41 may protrude to the outside of the connector 40 along the exterior of the connector. This may be done for reasons of ease of manufacture, or to allow for a thicker substructure profile, or for ornamental reasons, or for other reasons. The substructure may be molded in a first step, and then the structure laid in a mold in which the outer portion is overmolded onto the substructure.

FIG. 4D illustrates a cross-sectional view of a connector 40 according to some embodiments of the present invention. The substructure 41 is seen covered by the outer portion 42, but not along the exterior of the connector. FIG. 4E illustrates a cross-sectional view of the second end 44 of the connector 40. The ribs 46 of the skeletal substructure are seen with their external features protruding to the periphery of the connector.

In some embodiments, the substructure may be covered on the outer side in the ball region, and on the inner side in the socket region.

In some embodiments, the substructure may not be of an integral piece connected in the middle. In some embodiments, the substructure may not consist solely of finger protrusions from the neckdown of the connector up around the ball or socket portion of the connector, but may include some circumferential elements. In some embodiments, there may be circumferential element as part of a substructure with fingers protruding from it in one or both directions from the circumferential element. In some embodiments, the circumferential element may not be solely a band, but may include a zig-zag shape or other shape, which may also allow for more compliance in the circumferential element along the circumference.

In some embodiments, the substructure may be of metal, which may be stamped sheet metal. In some embodiments, the substructure may be of a material such as glass reinforced nylon.

In some embodiments of the present invention, as seen in FIG. 5, a connector 50 may have a substructure 52 and an outer portion 52. The substructure may have a circumferential element 53, 54, on one or both ends. In some embodiments, the substructure may be a unitary element which traverses both ends of the connector. In some embodiments, the substructure in the ball end, or the socket end, or both, may not be connected to the other end's substructure. The circumferential element 53, 54 may be connected to fingers which are part of the substructure, but which do not link up to other portions of substructure.

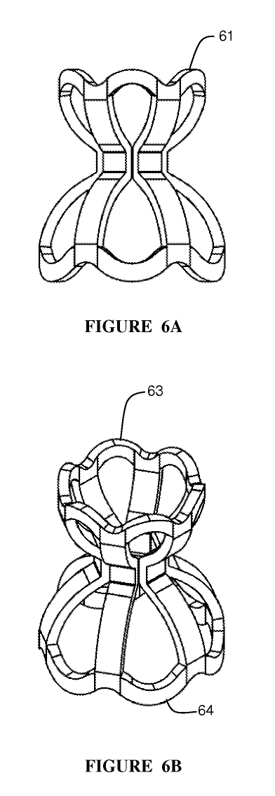

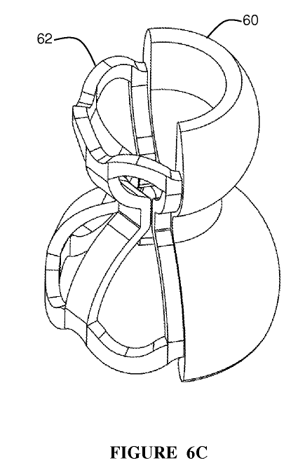

In some embodiments of the present invention, as seen in FIGS. 6A-C, a connector 60 may have a substructure 61 with an outer portion 62. The circumferential elements 63, 64 may have a non-linear circumferential aspect, such as a wavy design, which may be adapted to allow more compliance into the substructure. In some embodiments, the substructure may be a unitary piece for both ends. In some embodiments, only one end may have a substructure. In some embodiments, both ends may have a substructure which is not connected.

In some embodiments of the present invention, the connectors may have male connections on both ends, or may have female connections on both ends.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A connector comprising:
a connector body, said connector body comprising:
a first end portion;
a second end portion;
a socket engaging end surface at said first end portion, said socket engaging end surface being the external surface at said first end portion; and
an internal socket receiving cavity at said second end portion;
wherein said second end portion comprises a first substructure.

2. The connector of claim 1 wherein said first end portion comprises a second substructure.

3. The connector of claim 2 wherein said connector body further comprises an integrated substructure, said integrated substructure comprising said first substructure and said second substructure.

4. The connector of claim 1 wherein said first substructure comprises a plurality of support portions within f said internal socket receiving cavity.

5. The connector of claim 2 wherein said second substructure comprises a plurality of support portions within said socket receiving end portion.

6. The connector of claim 4 wherein said second substructure comprises a plurality of support portions within said socket receiving end portion.

7. The connector of claim 3 wherein said first substructure comprises a plurality of support portions within said internal socket receiving cavity.

8. The connector of claim 7 wherein said second substructure comprises a plurality of support portions walls of said socket receiving end portion.

9. The connector of claim 1 wherein said first substructure comprises a first circumferential element.

10. The connector of claim 9 wherein said first circumferential element comprises a non-linear circumferential band.

11. The connector of claim 2 wherein said first substructure comprises a first circumferential element.

12. The connector of claim 11 wherein said first circumferential element comprises a non-linear circumferential band.

13. The connector of claim 11 wherein said second substructure comprises a second circumferential element.

14. The connector of claim 13 wherein said second substructure comprises a non-linear circumferential band.

15. A connector body comprising:
a first end portion;
a second end portion, said second end portion having a first end connected to said second end portion, wherein each of said first end portion and said second end portion includes either
a socket engaging end surface as an external surface thereof, said socket engaging end surface being adapted to connect to an internal socket receiving cavity, or
an internal socket receiving cavity, said internal socket receiving cavity being adapted to connect to a socket engaging surface,
wherein one of said first end portion or said second end portion comprises a substructure.

16. The connector body of claim 16 wherein both of said first end portion and said second end portion comprises a substructure.

17. The connector body of claim 15 wherein said substructures comprise a circumferential band.

18. The connector body of claim 16 wherein said first end portion and said second end portion comprise substructure comprising circumferential bands.
